(19) United States
(12) Patent Application Publication
(10) Pub. No.: US 2023/0342495 A1
(43) Pub. Date: Oct. 26, 2023

(54) SELECTIVELY PERMISSIONED DATA ACCESS STORAGE AND METHOD

(71) Applicant: XINSERE INC., San Francisco, CA (US)

(72) Inventors: Mark Turner, Altadena, CA (US); Jeremy A. Katz, Jenkintown, PA (US); Joshua M. Katz, San Francisco, CA (US)

(21) Appl. No.: 18/302,559

(22) Filed: Apr. 18, 2023

Related U.S. Application Data
(60) Provisional application No. 63/332,837, filed on Apr. 20, 2022.

(51) Int. Cl. G06F 21/62; G06F 21/60

(52) U.S. Cl. CPC G06F 21/6263; G06F 21/602; G06F 2221/2101

(57) ABSTRACT

A system architecture and methods to enable a user (data provider) to selectively release some or all personal data to third parties (data consumers) who may then benefit from direct, precise, and permissioned audience data. The solution disclosed herein provides an open and transparent exchange (using a blockchain or other distributed ledger technology) whereby third parties can request permission to a user’s data and know they have received and continue to receive the user’s explicit permission (managed in a smart contract) to use the data. Users are provided a web portal or app interface where they can manage all of their issued permissions with all third parties across their devices and touch points with third parties. Users can update their data (e.g., address, email, or zip code) and know that permissioned third parties will always be updated.

### CROSS-REFERENCE TO RELATED APPLICATION

This application claims priority to U.S. Provisional Pat. Application No. 63/332,837, filed Apr. 20, 2022, entitled “SELECTIVELY PERMISSIONED DATA ACCESS STORAGE AND METHOD,” which is incorporated herein by reference in its entirety.

### BACKGROUND

Relationships between consumers and the brands that engage them through advertising or outreach can include a myriad of different mediums (online within browsers or apps, out of home, mobile, TV, etc.) and all use varying amounts of data to describe that relationship and often to set the value of a data exchange (like a paid advertisement). “Third-parties” and/or their registered Agents such as Ad-Agencies or data brokers (i.e., data consumers) may have a wide range of ways to engage different user groups (i.e., data providers). The consumers (users) may include known users that are engaged by email, text, mail outs, within apps and websites brands, and/or within media streams that are all operated where users are signed in. Another group of users are those who are unknown repeating users that engage within apps, media and websites who are not signed in, but tracked through use of tracking techniques (e.g., cookie) such that a repeating visitor can be identified. A next group of users includes unknown potential users and targets. Third parties can attempt to target such new users via ad-exchanges, online display advertising, sponsored search terms, ad placements within search results, sponsored pages/promos, sponsored podcasts/audio streams, streaming video ads, etc. Yet another group of users are unknown potential users and targets who use legacy media - these are broad demographic groups available from linear TV commercial spots, paid placements within programming, audio.

Brands (also data consumers) can engage the above user types across a myriad of ways, for example, out of home through billboard and digital outdoor advertising, interactive outdoor (kiosks, smart city), in audience venue (concerts, theaters, sporting events), in-store (smart shelves, at point of purchase), multi-party viewing (movie theaters, bars, venues). They may also engage users directly through user-owned devices, such as TVs (either via over the air, cable, satellite or over the top), smart phones, PCs, tablets, immersive headsets, wearables, implanted and other potential future consumer devices like connected cars. Brands may further engage users through users’ communication channels, e.g., in email, postal mail, text and other short message services.

In almost all cases, both the brands -- data consumers -- and users -- data providers -- end up with a mix of incomplete information about each other. This represents a challenge for both parties. In particular, users do not understand which brands have access to which parts of their data, on which devices. The third parties do not know whether they have a complete picture of the person-only a fragment of information from one device or class of data (like cookie tracking) and whether they have breached the myriad of national, regional, and local consumer data protection rules.

### SUMMARY

The present disclosure is directed to an architecture and associated methods to provide a mutual value exchange platform backed by a distributed ledger (blockchain) where data providers (e.g., individual users) can selectively release some or all of their personal data to trusted data consumers (e.g., publishers; brands; advertisers; data brokers; marketing technology providers; programmatic ecosystem participants; TV and online video producers, providers, and, distributors; content networks; retailers, service companies, financial institutions, governments and any other data consumers-either existing now or to be invented in the future-that data providers may wish to release data to) who may benefit from direct, precise, and permissioned audience data.

Instead of sharing their data with anonymous companies and tracking services (via cookies on their machines), users are empowered to share their data in a value exchange with organizations with very finite controls for what can be shared. As will be described below, users’ Personally Identifiable Information (PII) and device usage information (non-PII) is stored in a distributed architecture via an “emblem” (an encrypted data store) either on their devices or elsewhere. A web portal or app interface allows consumer to view, edit and remove permissions to their data. A service provider does not hold and cannot directly access consumers PII data but instead brokers third parties who are able to transparently access that information.

A blockchain or other distributed ledger technology may be used to track transactions between consumers and third parties. Consumers’ personal data is not stored in the distributed ledger, but the contractual agreements and therefore the permissions are traceable and therefore cannot be manipulated.

In accordance with the present disclosure, a system to audit permissions for sharing of consumers Personally Identifiable Information (PII) is described. The system includes a data provider device that controls the sharing of PII that is stored in an emblem or Distributed Permissioned Data (DPD) Network; a service that stores data associated with the data provider, the associated data being data that is non-personal or non-private; and a distributed ledger infrastructure that stores permissioned contracts that define where and how the PII is to be shared with a data consumer. A corresponding method implemented by the components within the system is also described herein.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a pictorial representation of a network of data processing systems in which illustrative embodiments may be implemented;

FIG. 2 illustrates an account creation process in accordance with the present disclosure;

FIG. 3 illustrates a process by which third-party data permissions are set in accordance with the present disclosure;

FIG. 4 illustrates a process by which third-parties read protected personal data in accordance with the present disclosure; and

FIG. 5 illustrates a process by which third-party data permissions are withdrawn or modified in accordance with the present disclosure.

### DETAILED DESCRIPTION

The present disclosure provides a description of a system and methods to enable a user to selectively release some or all personal data to data consumers who may then benefit from direct, precise, and permissioned audience data. The solution disclosed herein provides an open and transparent exchange (using a blockchain or other distributed ledger technology) whereby third-parties can request permission to a user’s data and know they have received and continue to receive the user’s explicit permission (managed in a smart contract) to use the data. Users are provided a web portal or app interface where they can manage all of their issued permissions with all third parties across their devices and touch points with third parties. Users can update their data (e.g., address, email, or zip code) and know that permissioned third parties will always be updated.

In accordance with the present disclosure, third-parties can request access to user personal data in a number of ways or combination thereof:
Specific User, PII Data - e.g., a name, address or email for a specific user naming their specific provider ID
Specific User, Non-PII Data - e.g., web tracking usage or affiliated brands which does not identify the user beyond the provider ID
Unspecified User, Non-PII Data - e.g., without knowing a user or anything to identify them a medical researcher could request health information about users in America with high cholesterol aged over 30.
Unspecific User, Aggregated Non-PII Data - e.g., Advertisers or publishers can request audience data with high level demographics and their usage (e.g., women 18-34 in zip code A) and which brands they are interested in. Such a request is not specific to any user.

Users can send permissioned data to third parties if they elect to receive the permissions for it. For example, the data may include specific User PII or Non-PII data, which may be communicated when a user elects to send permissioned financial information to a retailer for a specific purchase.

In accordance with the present disclosure, the user may select which data points they are prepared to share with third-party. Each can be controlled independently for each contract with each third-party offering profoundly nuanced relationships. For example, the user may share the following nonlimiting information with third parties on a limited or no duration basis:
first name
middle name(s)
last name
gender
year of birth, month of birth, date of birth
relationship with other IDs, e.g., spouse, children, friends, other family members
mailing address
zip or postal code
email address
mobile phone number
usage information on third-party’s sites and access
usage information on other websites
optional fields that may be specific to use cases
brands followed by the user
products and services that the user likes
active purchase decisions that the user is considering
specific health records
affiliations and memberships
political affiliation
Social Security number or other state information
banking or credit information.

The above may be enhanced by using a Distributed Permissioned Data storage system so users can be assured that all of their data in the system is stored securely and cannot be hacked by any non-permissioned actor.

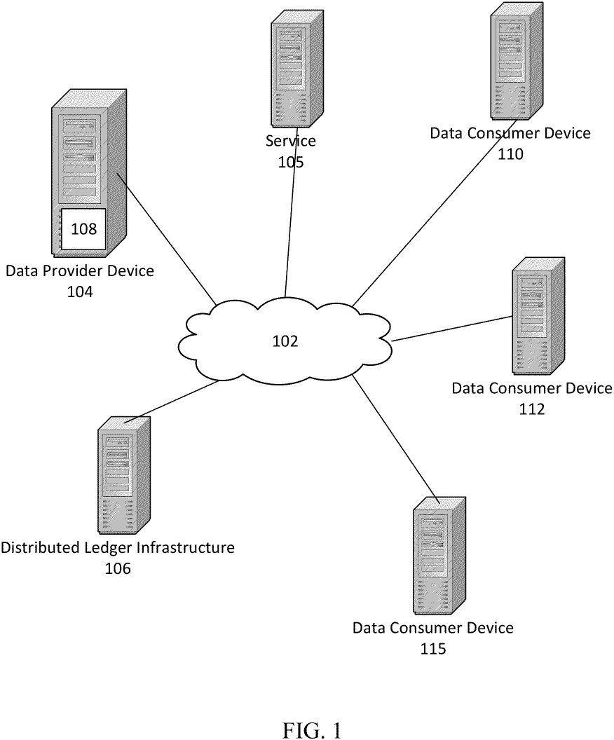

With reference now to FIGS. 1-3, there are illustrated overviews of example data processing environments in which the present disclosure may be embodied. FIGS. 1-3 are provided as examples and are not intended to be non-limiting, as modifications to the environments may be made and remain within the scope of the claims.

FIG. 1 illustrates a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, fiber optic cables, and the like.

In FIG. 1, data provider device 104, service 105, and distributed ledger infrastructure 106 connect to network 102. Data provider device 104, service 105 and distributed ledger infrastructure 106 may be, for example, computing device with communications connections to network 102. In addition, data provider device 104, service 105 and distributed ledger infrastructure 106 provide services to data consumer devices. For example, data provider device 104 controls the process of sharing personal data stored in storage 108, which may correspond to one or more data owners (users), with data consumer devices. The personal data may be any personal information, such as, for example, name, address, social security number, medical history, personal preferences, and the like, that may be associated with a particular data owner. A data owner creates and owns the corresponding digital identity data. Storage 108 is capable of storing any type of data in a structured format or an unstructured format. Further, storage 108 may not store the data directly, rather it may pass the data along in the network 102. In one implementation, storage 108 comprises an “emblem,” which is a data store encrypted and stored on consumers device(s). Storage 108 may contain the following non-limiting types of information and may be viewed and edited by users of the data provider device 104:
Full Name
Email Address(s)
Cell number(s)
Mailing address plus Zip
Date of birth/Age
Relationships to other consumers
Employer

Service 105 may be a service provider that stores other types of data associated with data providers that is not personal or private. For example, storage within the service 105 may contain the following non-limiting types of information and may be viewed, but not edited by users of the data provider device 104:
Device IDs
Browser/App IDs
Search history
Web history, by device
Video viewing history, by device
Click data on ads, by device
Registered areas of interest

As will be described below, a data owner or user may precisely control how some or all of their personal data is released to a data consumer. Distributed ledger infrastructure 106 may store permissioned contracts to provision access to the personal data received from data provider device 104. As used herein, a “permissioned contract” may be a smart contract, stored in a distributed ledger infrastructure 106, which defines the relationship between a data consumer 110, 112 or 144 and specific data providers that consumer may have elected to share some or all of their personal data The details of a permissioned contract are described below. A data provider may be an individual person, each of which is allocated a unique provider ID in the system. Provider IDs can be linked to devices and to other provider IDs to enable, for example, parental controls, family groups or groups of users and devices controlled by an enterprise. If the data provider has more than one data provider device 104, then such multi-device usage is tracked by linking each device emblem to a unique provider ID.

It should be noted that different permissioned contracts may be executed by the distributed ledger infrastructure 106 in accordance with how a data owner wishes to share his or her personal data. The data provider device 104 and distributed ledger infrastructure 106 may each represent a cluster of servers in one or more data centers. Alternatively, data provider device 104 and distributed ledger infrastructure 106 may each represent multiple computing nodes in one or more cloud environments.

Data consumers 110, 112, and 114 are individuals, corporate entities, government entities, brokers, and other third parties with whom a data provider 104 has elected to share some or all of his or her personal data. Data consumers 110, 112, and 114 may access the network 102 using, for example, network computers, desktop computers, laptop computers, handheld computers, smart phones, smart watches, smart televisions, gaming devices, kiosks, and the like, with wire or wireless communication links to network 102. Data consumers 110, 112 and 114 may also include the following non-limited entities: brands, advertisers, publishers, brokers, government entities, doctors or health care systems or B2C services like e-commerce. Each of data consumers 110, 112 and 114 is represented by unique consumer ID.

In the depicted example, network data processing system 100 may be implemented as a number of different types of communication networks, such as, for example, an internet, an intranet, a local area network (LAN), a wide area network (WAN), a telecommunications network, or any combination thereof. FIG. 1 is intended as an example only, and not as an architectural limitation for the different illustrative embodiments. Furthermore, it should be noted that network data processing system 100 may include any number of additional servers, clients, storage devices, and other devices not shown. Moreover, the distributed ledger infrastructure 106 may represent a blockchain network of interconnected nodes.

Example Implementations within the System 100

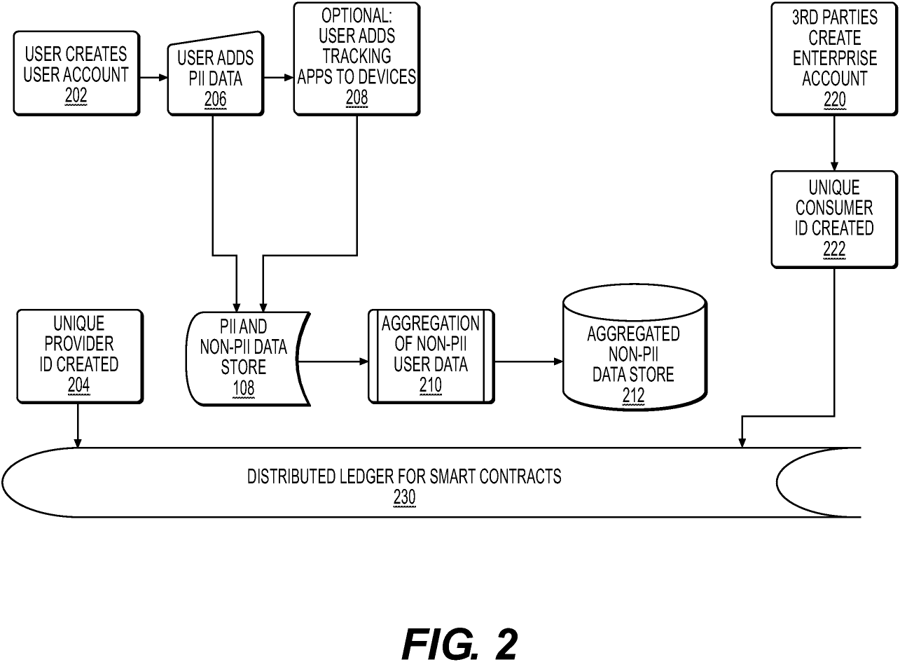

Referring to FIG. 2, there is shown an account creation process 200 in accordance with the present disclosure. At 202, a user creates an account. For example, a user may create account using a data provider 104 account creation mechanism. At 204, the unique provider ID is created that is associated with the user. At 206, the user adds personal data that is associated with the account by his or her unique provider ID. Personally Identifiable Information (such as name, DOB, address, etc.) may be saved to the local data store 108 or to a Distributed Permissioned Data (DPD) Network. Optionally, at 208 a user may add tracking applications to one or more of their data provider devices 104. For example, users may download apps on their devices, or use browsers that track their media and consumption habits across all devices (all of which is non-PII). At 210, the service 105 aggregates consumer’s non-PII data on to shared storage 212, without attaching any PII data to it.

In addition to the user account creation process, there is third-party (data consumer) account creation process that begins at 220. When a third-party creates an account with the service 105, a unique consumer ID is created for that entity. At 222, after user and third-party accounts are created, users and third parties establish contracts 230 (described below) with the service 105 that generates an anonymous ID to represent each.

As contemplated by the present disclosure, no user data is ever stored on the public blockchain or the third-party servers, rather PII data is stored on the user’s data provider device 104 or Distributed Permissioned Data (DPD) Network, and non-PII data is stored by the service 105 or by the DPD Network.

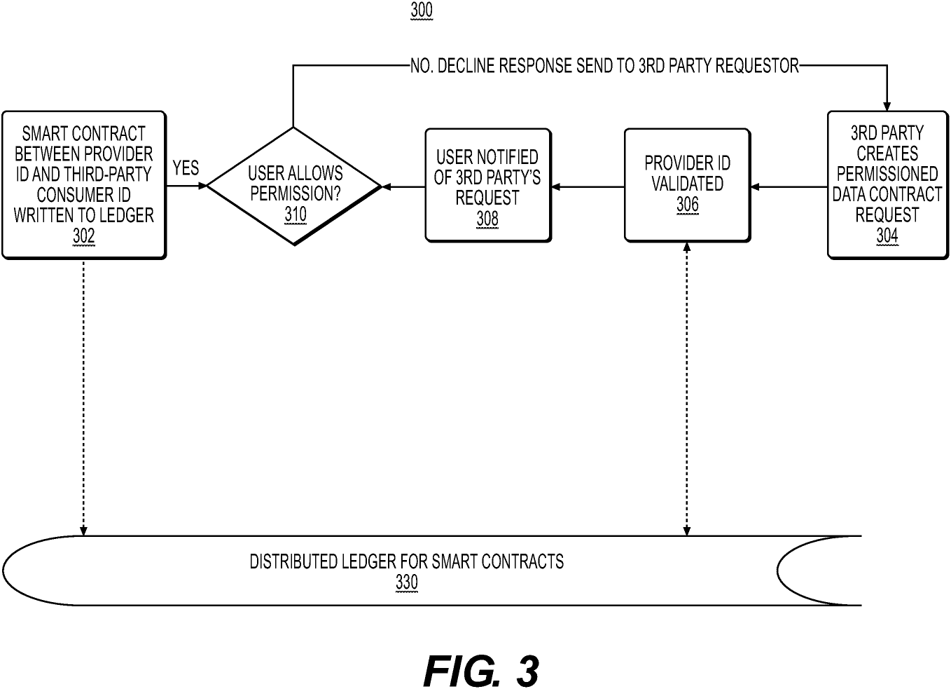

Referring to FIG. 3, there is shown a process 300 by which third-party data permissions are set in accordance with the present disclosure. At 302, a smart contract between a unique provider ID and unique consumer ID is written to a ledger, such as a blockchain. At 304, the third-party creates a permission data contract request. When a third-party wants to establish permissions for some or all user data they create a Permissioned Data Contract Request which specifies one or more provider IDs and the requested data and duration. If no provider ID is specified, the offer may be considered non-user specific and can be made to any user that matches the criteria of the request. Optionally, the requesting party can offer something of value to the user to encourage them to accept their data permission request.

The permission contract request may include the following nonlimiting information:
Requesting Parties unique consumer ID
Date, Time Request initiated
Expiry Date, Time if Permission Request will time out if not accepted
Duration of Data Requested (0 for perpetual until cancelled)
Provider ID(s) (if known, blank for unspecified)
If no Provider IDs are included target information should be specified to target the offer to relevant target groups for example gender, location, age, income level etc.
Fields of data requested (e.g., one of the fields noted above)

As only provider IDs and consumer IDs are written to the public ledger, no identifiable information is published that could show which consumer or organization are behind each smart contracts. As noted above, the service provider does not need to know PII data for a particular user to be able to make or receive offers for their PII or non-PII data. In addition, consumers need to explicitly share their PII data with the service provider for the service provider to provide aggregation of that information to data requesters.

Optionally, at 306 a provider ID is validated in accordance with the request at 304, and the user is notified of the third-party request at 308. At 310, if the user allows permission to the data associated with the contract request. In accordance with the present disclosure, consumers can set permissions on a category basis, for example all brands in the cosmetics or news categories. The service 105 may preconfigure all permissions for those brands. If so, the third-party is granted access to the personal data that is the subject of the request. However, if not, the third-party is notified that the user has declined the permission data contract request.

Although FIG. 3 illustrates a process whereby a third-party creates the permission data contract request, the inverse may also take place. A user can offer to create a smart contract to permission their data with certain third-parties. The contract is formed when the third-party accepts the permission request from user.

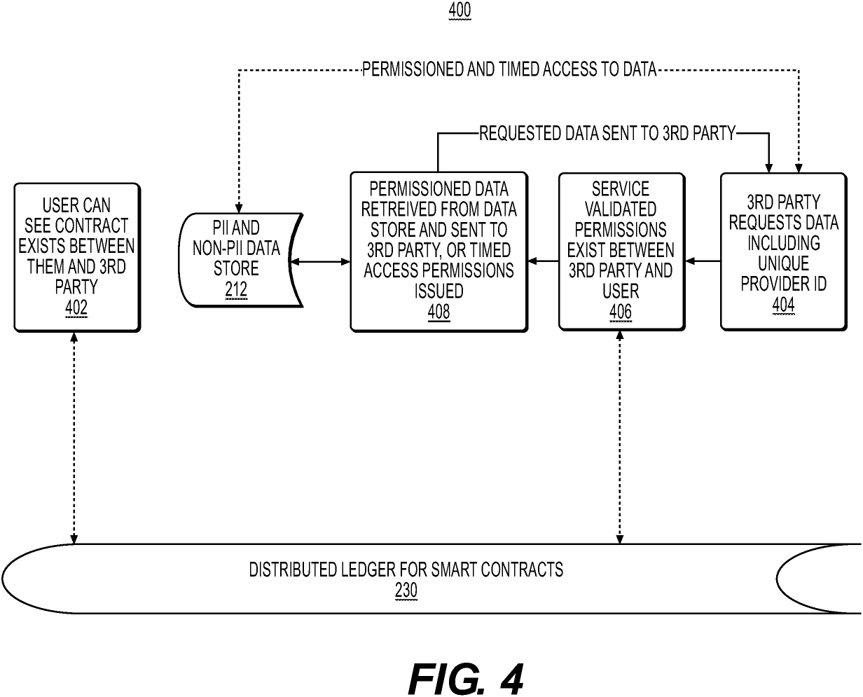

Referring to FIG. 4, there is shown a process 400 by which third-parties read protected personal data in accordance with the present disclosure. At 402, a user can see that a contract exists between them and a third party. At 404, the third-party requests data including the unique provider ID. At any point the permissioned third-party can request data that they have approved access to. The process includes sending a data request message to the service 105.

At 406 the service validates that permissions exist between the third-party and the user. The service 105 validates that the third-party does indeed have current access permissions by checking the distributed ledger.

At 408, permission data is received from the data store 212 and since the third-party or timed access permissions are issued. The service 105 requests the permissioned data from the data store 212 which is either permissioned to allow the third-party to read-only the data records from the PII and Non-PII Data Store, or copied and sent to the requesting third-party

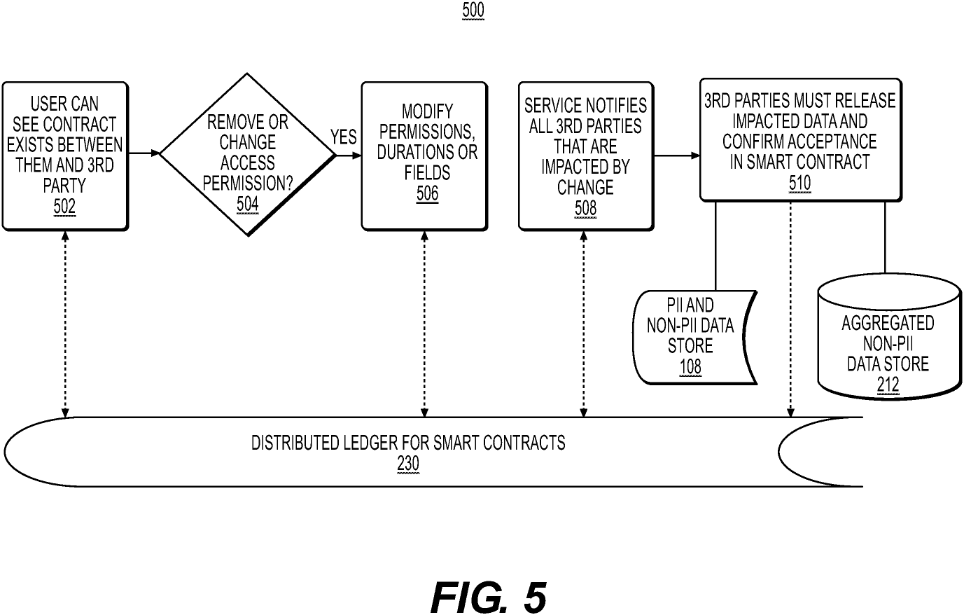

Referring to FIG. 5, there is shown there is shown a process 500 by which third-party data permissions are withdrawn or modified in accordance with the present disclosure. At 502 a user can see the contract exists between them and a third party. At 504, it is determined if the user desires to remove or change access permissions. At any point users may withdraw, change, or reduce the permissions shared with third parties. They can check their permissions by using a service that queries the distributed ledger and reads back the third-parties that have access to their data, and specifically which fields are shared. At 506, the user is provided an interface to modify permissions, durations or fields.

At 508, in response to any modification made 506, the service notifies all third parties that are impacted by the change in permissions. At 510, third parties then must release impacted data and confirm acceptance in a smart contract. If users change any of these contractual elements the service notifies any third-parties which are impacted by the change or removal of rights and what has changed. If the third parties have copies of impacted consumer data, they must delete that data and report back to the ledger that they are in compliance with the new agreement. This may include data stored in the aggregated data store 212 or the data store 108. Optionally, third-parties can make an offer through the service of some sort of value exchange back to consumers to restore the removed permissions

### Example Use Cases

The following are example use cases within the system 100:

Third parties can make offers to consumers and potential consumers through payments, gifts, or other value in exchange to access to their data.

Consumers can store other highly secure information which they may want to share with trusted third parties such as e-wallet/credit card information, driver’s license, social security or other ID, political affiliation, voting records, healthcare records, insurance information etc.

User IDs can be aggregated into groups so policies can be set for groups of users. For example; a family of users could be linked so their usage on one device (e.g., a smart TV) could be shared with for all of them; an enterprise could aggregate user IDs and control which third-parties can access certain information (e.g., stop competitors or known hackers being able to request tracking permission from any device owned by the enterprise).

Users can choose to delegate their permissions for example, a child’s permissions could be controlled by an adult.

The service can define groups of permissions (e.g., strict, moderate, liberal) which predefines permissions for different third parties to enable consumers to quickly apply and modify granular permissions.

Third parties can control and understand which users have signed certain terms and conditions across devices, e.g., replacing cookies across devices so user acceptance on one device propagates to other devices. Any changes in Terms and Conditions can be sent out to any consumer who accepted the previous ones.

### Example Operating Environment

Components within the system 100 show in in FIG. 1, may be one or more data processing systems that may be a computer in which computer readable program code or instructions implementing processes of illustrative embodiments may be located. In this example, data processing system includes a processor unit, a memory, persistent storage, input/output (I/O) devices, and display.

The processor unit serves to execute instructions for software applications and programs that may be loaded into memory. The processor unit may be a set of one or more hardware processor devices or may be a multi-core processor, depending on the particular implementation. The memory and persistent storage are examples of storage devices. A computer readable storage device is any piece of hardware that is capable of storing information, such as, for example, without limitation, data, computer readable program code in functional form, and/or other suitable information either on a transient basis or a persistent basis. The memory, in these examples, may be, for example, a random-access memory (RAM), or any other suitable volatile or non-volatile storage device, such as a flash memory. The persistent storage may take various forms, such as a hard disk drive, a solid-state drive, a rewritable optical disk, a rewritable magnetic tape, or some combination of the above. The media used by persistent storage may be removable. For example, a removable hard drive may be used for persistent storage.

Communications between data processing systems and devices maybe performed via a network, such as network 102 in FIG. 1. Communications may be provided through the use of both physical and wireless communications links. The physical communications link may utilize, for example, a wire, cable, universal serial bus, or any other physical technology to establish a physical communications link for data processing system. The wireless communications link may utilize, for example, shortwave, high frequency, ultrahigh frequency, microwave, wireless fidelity (Wi-Fi), BLUETOOTH technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output devices allows for the input and output of data with other devices that may be connected to data processing system 200. For example, the input/output devices may provide for user input through a keypad, a keyboard, a mouse, a microphone, and/or some other suitable input device. The display provides a mechanism to display information to a user and may include touch screen capabilities to allow the user to make on-screen selections through user interfaces or input data, for example.

Instructions for the operating system, applications, and/or programs may be located in storage devices, which are in communication with processor unit. The instructions are in a functional form on the persistent storage. These instructions may be loaded into memory for running by processor unit. The processes of the different embodiments may be performed by processor unit using computer-implemented instructions, which may be located in a memory, such as memory. These program instructions are referred to as program code, computer usable program code, or computer readable program code that may be read and run by a processor in processor unit. The program instructions, in the different embodiments, may be embodied on different physical computer readable storage devices, such as memory or persistent storage.

Program code is located in a functional form on a computer readable media that is selectively removable and may be loaded onto or transferred to data processing system for running by processor unit. Program code and computer readable media form computer program product. In one example, computer readable media may be computer readable storage media or computer readable signal media. Computer readable storage media may include, for example, an optical or magnetic disc that is inserted or placed into a drive or other device that is part of persistent storage for transfer onto a storage device, such as a hard drive, that is part of persistent storage. Computer readable storage media also may take the form of a persistent storage, such as a hard drive, a thumb drive, or a flash memory that is connected to data processing system. In some instances, computer readable storage media may not be removable from data processing system.

Alternatively, program code may be transferred to data processing system using computer readable signal media. Computer readable signal media may be, for example, a propagated data signal containing program code. For example, computer readable signal media may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

The different components described above for the data processing system are not meant to provide architectural limitations to the manner in which different embodiments may be implemented. The different illustrative embodiments may be implemented in a data processing system including components in addition to, or in place of, those illustrated for data processing system.

Thus, the system architecture described herein solves many limitations in the art, including, but not limited to enabling a data providers (users) to selectively release some or all personal data to data consumers who each may then benefit from direct, precise and permissioned audience data.

What is claimed:

1. A system to audit permissions for sharing of consumers Personally Identifiable Information (PII), comprising:
a data provider device that controls the sharing of PII that is stored in an emblem or Distributed Permissioned Data (DPD) Network;
a service that stores data associated with the data provider, the associated data being data that is non-personal or non-private; and
a distributed ledger infrastructure that stores permissioned contracts that define where and how the PII is to be shared with a data consumer.

2. The system of claim 1, wherein the emblem is an encrypted data store.

3. The system of claim 1, wherein the sharing of PII is performed in compliance with national, regional and local laws and can be audited to validate that permissions are compliant.

4. The system of claim 1, wherein the permissioned contract defines specific data that a consumer has elected to share with the data consumer.

5. The system of claim 4, wherein the permissioned contract defines a duration that the specific data will be shared with the data consumer.

6. The system of claim 4, wherein the permissioned contract is revokable such that the specific data is no longer available to the data consumer.

7. The system of claim 4, wherein the service validates permissions between the data consumer a consumer.

8. The system of claim 4, wherein the data consumer is identified by a consumer ID and the consumer is identified by a unique provider ID stored in the distributed ledger infrastructure.

9. The system of claim 8, wherein the unique provider ID is linked to a device emblem associated with a device to enable per-device controls.

10. The system of claim 1, wherein the PII is stored to a Distributed Permissioned Data (DPD) Network.

11. A method to audit permissions for sharing of consumers Personally Identifiable Information (PII), comprising:
controlling, at a data provider device, the sharing of PII that is stored in an emblem or Distributed Permissioned Data (DPD) Network;
storing, at a service, data associated with the data provider, the associated data being data that is non-personal or non-private; and
storing, in a distributed ledger infrastructure, permissioned contracts that define where and how the PII is to be shared with a data consumer.

12. The method of claim 11, wherein the emblem is an encrypted data store.

13. The method of claim 11, further comprising sharing the PII in compliance with national, regional and local laws that can be audited to validate that permissions are compliant.

14. The method of claim 11, further comprising defining specific data that a consumer has elected to share with the data consumer in the permissioned contract.

15. The method of claim 14, further comprising defining a duration that the specific data will be shared with the data consumer in the permissioned contract.

16. The method of claim 14, further comprising revoking the permissioned contract to no longer make the specific data available to the data consumer.

17. The method of claim 14, further comprising validating, at the service, the permissions between the data consumer a consumer.

18. The method of claim 14, further comprising identifying the data consumer by a consumer ID and the consumer by a unique provider ID that is stored in the distributed ledger infrastructure.

19. The method of claim 18, further comprising linking the unique provider ID to a device emblem associated with a device to enable per-device controls.

20. The method of claim 11, further comprising storing the PII to a Distributed Permissioned Data (DPD) Network.
